(19) United States
(12) Patent Application Publication
(10) Pub. No.: US 2017/0152104 A1
(43) Pub. Date: Jun. 1, 2017

(54) WASTE SORTING DEVICE

(71) Applicant: KTG Sp.z.o.o., Warszawa (PL)

(72) Inventor: MARCIN GROCHOWINA, RZESZÓW (PL)

(73) Assignee: KTG Sp.z.o.o., WARSZAWA (PL)

(21) Appl. No.: 14/433,928

(22) PCT Filed: Jul. 24, 2014
(86) PCT No.: PCT/PL2014/000087

§ 371 Date: Apr. 7, 2015

(30) Foreign Application Priority Data
Jun. 29, 2014 (PL) P.408691

(51) Int. Cl. B65F 1/00; B07C 5/344

(52) U.S. Cl. CPC B65F 1/004; B07C 5/344; B07C 2501/0054; B65F 2210/162; B65F 2210/1522; B65F 2210/1525; B65F 2210/1527; B65F 2210/168; B65F 2210/176

(57) ABSTRACT

A waste sorting device is characterized in that it is equipped with a waste collection tank coupled to a press (1), a set of sensors (4) submitting information to a controller system (2) which starts an initiated process of crushing with the press (1), during which the set of sensors (4) examines the object in terms of physical properties, and on the basis of signals form a position sensor (5), it opens a trapdoor (6) of the container for waste segregation. Below the collection tank and the press (1), it has a rotatable container for waste segregation, controlled by the controller (2), and rotated for segregation by means of a drive (3). The controller (2) starts the crushing process, and the set of sensors (4) analyzes the hardness, on the basis of resistance to compression, electrical conductivity, magnetic permeability, and then the controller (2) specifies the material from which the segregated waste is made.

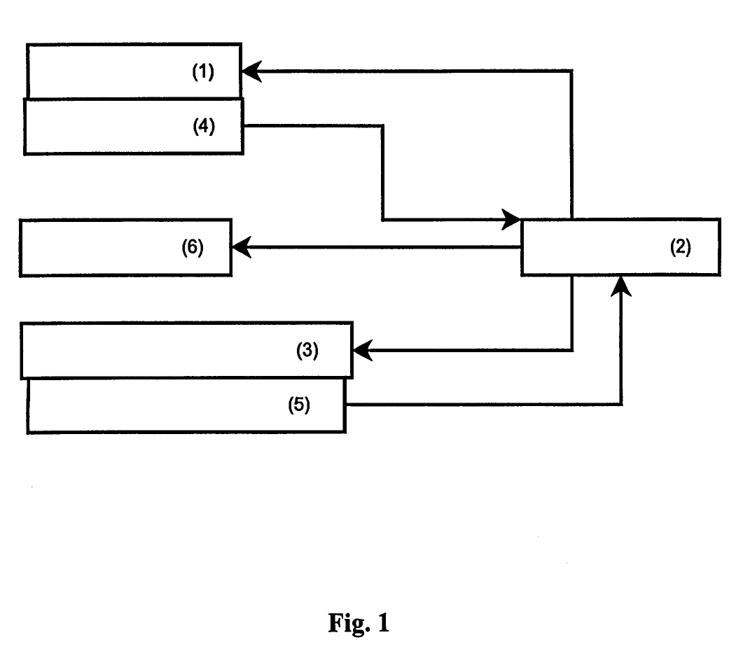

The object of the invention is a device for communal waste segregation, the waste being produced especially in households and in infrastructure facilities which do not produce hazardous waste.

Nowadays, still increasing amount of communal waste accumulated on relatively small storage space causes a negative impact on the natural environment, therefore before finally placing it in the landfill, it is subjected to segregation, to physical, biological or other transformation.

A statistical inhabitant of our country “produces” annually about 350 kg of waste, wherein a large part of the waste can be reduced by segregation. Further, the cost of waste collection by specialized companies often depends on whether the waste is sorted or not, segregated waste being collected at a lower price. To facilitate waste segregation at the stage of their formation in households, special containers or sets thereof, i.e. segregators, are used. The simplest models have two containers; for organic waste, intended for compost, and for other waste. The most complex models are equipped with up to 6 containers and with shelves and lockers for, among others, used batteries or burnt out fluorescent lamps. Thanks to daily segregation, the amount of waste can be reduced even by half, and consequently bills for their collection can be reduced. However, the need to use several containers or a multisection container remains problematic.

Normally, segregation requires the use of five containers: for compost, glass, paper, plastic and metals.

From patent specification PL210797, a separation system for communal waste and particularly for fine fraction recovery, used by the manufacturer of the waste sorting plant, comprising a feeding conveyor equipped, at its beginning, with a storage tank and extending above a sieve of an oscillating screen, under which the beginning of a first discharging conveyor is placed, and the material from above the sieve of the oscillating screen falls at the beginning of a second conveyor, is known. A storage tank, before the feeding conveyor, is placed above the conveyor in its axis. The fine fraction recovery is moved by the first discharging conveyor directly onto the trailer of a transport vehicle.

The second discharging conveyor is set perpendicularly to the axis of the feeding conveyor.

In order to achieve greater economic use of the communal waste, a separation system was developed which increases the efficiency of recycling.

The system, known form the invention, consists of a double-deck oscillating screen with an upper sieve deck connected at the input in series with the feeding conveyor, and at the output in series with a ballast conveyor and a lower sieve deck connected at the output in series with the ballast conveyor and in parallel from below with a below/sieve conveyor, wherein the ballast conveyor supplies with the fraction feed of over/dimensional cabin for manual sorting. A disadvantage of the known solution is its complexity and large dimensions of conveyors and screens in a system of serial connections.

Surprisingly, it turned out that the problem can be substantially solved using an automated waste segregator which will make the selection and separation of waste thrown into it and will make it thrown to a suitable storage tank.

The essence of the solution according to the invention lies in the fact that the device for automated segregation is equipped with a reader analyzing parameters of the waste, and in particular pressability, electrical parameters, magnetic parameters and sounds during the pressing operation, wherein the analysis involves inorganic wastes, i.e. waste which is not subject to composting, the waste is separated into four sections: glass, paper, plastic and metal, and the waste subjected to segregation is partially pressed, which additionally affects the ecological aspect of the solution. Identification of the type of waste consists in the analysis of its behavior during the pressing process.

Such characteristics as pressability, electric and magnetic parameters or sound emitted during compression are analyzed. An object identified and classified to a certain group, as a result of the process, goes to a suitable storage tank.

As a result, the user makes by himself only the simplest selection, i.e. into biological waste and other waste, while the rest is addressed by a specialized sorter.

The object of the invention is illustrated as an embodiment in the Figure in the form of a block diagram. After throwing an object (waste) into an intake tank 1, a sensor 4 informs a controller 2 about it, the controller starts an initiated crushing process during which a set of sensors 4 examines the object in terms of physical properties, such as hardness, on the basis of resistance to compression, electrical conductivity, magnetic permeability etc. On this basis, the controller 2 specifies the material from which the object is made. By turning the container divided into sections by means of a drive 3, it sets, through signals from a position sensor 5, a section intended for collection of a particular category of waste under the intake tank 1 and opens a trapdoor 6. The object goes into a specific section of the container.

The use, preferably in the system according to the invention, of additional known devices for crushing, baling and pressing components of waste allows a higher reusability of waste, and therefore reduction in volume of waste unsuitable for further use, thus implementing a postulate for minimizing environmental nuisance.

1. A sorting device for communal waste, especially for its automated segregation, equipped with a waste collection tank and a container for segregated waste, characterized in that it is equipped with a waste collection tank coupled to a press (1), a set of sensors (4) submitting information to a controller system (2) which starts an initiated process of crushing with the press (1) during which the set of sensors (4) examines the object in terms of physical properties, and on the basis of signals form a position sensor (5), it opens a trapdoor (6) of the container for waste segregation.

2. The sorting device according to claim 1, characterized in that below the collection tank and the press (1), it has a rotatable container for waste segregation, controlled by the controller (2), and rotated for segregation by means of a drive (3).

3. The sorting device according to claim 1, characterized in that the controller (2) starts the crushing process, and the set of sensors (4) analyzes the hardness, on the basis of resistance to compression, electrical conductivity, magnetic permeability, and then the controller (2) specifies the material from which the object is made.
